(19) United States
(12) Patent Application Publication
(10) Pub. No.: US 2005/0214432 A1
(43) Pub. Date: Sep. 29, 2005

(54) Process for the preparation of an emulsion

(75) Inventors: Maria Teresa Belmar, Bedfordshire (GB); Kathleen Mary Burrows, Bedfordshire (GB); Rachel Ching-Yee Chow, Bedfordshire (GB); Dudley Paul Ferdinando, Bedfordshire (GB); Julia Helen Telford, Bedfordshire (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc.

(21) Appl. No.: 11/086,481

(22) Filed: Mar. 22, 2005

(30) Foreign Application Priority Data
Mar. 24, 2004 (GB) 0406635.3

(51) Int. Cl. A23L 1/238

(52) U.S. Cl. 426/589

(57) ABSTRACT

The invention provides a process for the preparation of a stable ungelatinised starch-containing oil-in-water emulsion in the absence of an added emulsifier which comprises subjecting a mixture of flour and/or starch, an oil and an aqueous liquid to high shear. A stable oil-in-water emulsion containing ungelatinised starch obtainable by the above process is also provided as well as a food product obtainable by heating the emulsion.

This invention relates to a process for the preparation of a stable ungelatinised starch-containing oil-in-water emulsion in the absence of an added emulsifier.

### BACKGROUND AND PRIOR ART

During the production of a starch based sauce, such as a white sauce, a chef will combine a native (unmodified) flour, butter (oil) and milk. However, the manner in which the ingredients are mixed together is critical to prevent clumping and the production of a lumpy sauce. Conventionally, a chef will mix together the flour and butter whilst heating to form a roux. The milk is then added to the roux and the mixture must be stirred and heated to 85° C. for at least 20 minutes to produce a white sauce.

This process has been developed over many years and, although the scientific importance of each of the stages is not fully understood, studies have shown that a high quality white sauce can only be produced when a roux is used and a heating regime followed as set out above. However, it will be appreciated that the traditional process is both time-consuming and complex. Moreover, a considerable amount of skill is required to produce a smooth sauce with a good texture.

GB 2 267 207 discloses a method of making a white sauce via the traditional roux method. The starch in the roux is maintained in an ungelatinised form, by mixing with a milk component at a low temperature, which gives a low viscosity product. The low viscosity product can be stored and only upon heating does the starch gelatinise to form a food product. However, because the process uses the roux route, the process takes a long time and involves heating.

Numerous attempts have been made to find an alternative method for producing such sauces which avoids the use of a roux. For instance, U.S. Pat. No. 5,895,676 describes a process for producing a roux-like binding agent for foodstuffs in which fine particles of farinaceous material are transported into an enclosed particle coating zone where a molten, high-melting point fat is sprayed, in the form of fine droplets, onto the particles to coat them. At the same time, the coated particles are cooled to a temperature below the melting point of the fat using chilled gas. The coated particles are flowable and disperse readily in hot water.

U.S. 2001/0026833 discloses a process for making a food product by mixing together water, fat and pregelatinised starch under high shear. The process produces a homogenous sauce without the need for emulsifiers or heating. However, because the starch is pregelatinised, it is broken down in the high shear process. This therefore gives a texture which is different to a sauce made via a roux.

U.S. Pat. No. 4,689,239 discloses a process for making a dairy-based sauce comprising mixing together milk, butter and corn starch, heating to from 140 to 190° F. (60 to 88° C.) for 10 minutes and then homogenising the mixture. Thus the starch is gelatinised before and after homogenisation.

JP 62186769 and JP 10327822 disclose a high temperature homogenisation process to produce a food sauce.

JP 59109143 discloses a process for making a white sauce wherein the starch gelatinises, which causes the produced sauce to be gluey in texture.

JP 8294375 describes a process for preparing a homogeneous sauce from a mixture of an oil or fat component, cereal flour, a milk component and/or water which is said not to require skilled labour. In this process, a mixture of the oil or fat component, milk component and/or water is subjected to a first homogenisation treatment. Cereal flour is then added to the homogenised mixture and the resultant mixture is partially gelatinised by heating. A sauce is then produced by a second homogenisation of the thermally gelatinised liquid mixture.

JP 7265022 describes a process for the preparation of a uniformly gelatinised white sauce having a smooth texture which is useful for gratin, stews etc. It is produced by blowing steam into the raw liquid mix to heat it whilst simultaneously subjecting the liquid sauce mix to ultrasonic waves of 20-50 kHz.

It will be apparent from the representative selection of documents discussed above that most prior art processes which avoid the preparation of a roux are themselves relatively complex and time-consuming. It is therefore an object of the present invention to provide a viable alternative to a roux which allows a decreased process time whilst retaining or increasing process flexibility.

### SUMMARY OF THE INVENTION

It has now been surprisingly found that a stable oil-in-water emulsion can be prepared, in the absence of an added emulsifier, which can be stored in a refrigerator and then heated when required to produce the final food product, such as a sauce.

It will be apparent that, since the emulsion of the invention can be stored in a refrigerator ready for use and then simply heated to produce the final product, the overall process time is decreased. Also, it is possible to produce a variety of food products starting from the same basic emulsion simply by adding a variety of different further ingredients. Process flexibility is therefore increased.

According to a first aspect of the present invention there is therefore provided a process for the preparation of a stable ungelatinised starch-containing oil-in-water emulsion in the absence of an added emulsifier which comprises subjecting a mixture of ungelatinised flour and/or starch, an oil and an aqueous liquid to high shear carried out at a temperature of less than 50° C.

In another aspect, the invention provides a stable oil-in-water emulsion obtainable by a process according to the first aspect.

In another aspect, the present invention provides a stable ungelatinised starch-containing oil-in-water emulsion in the absence of an added emulsifier characterised in that it has a microstructure comprising oil-protein complexes or associations.

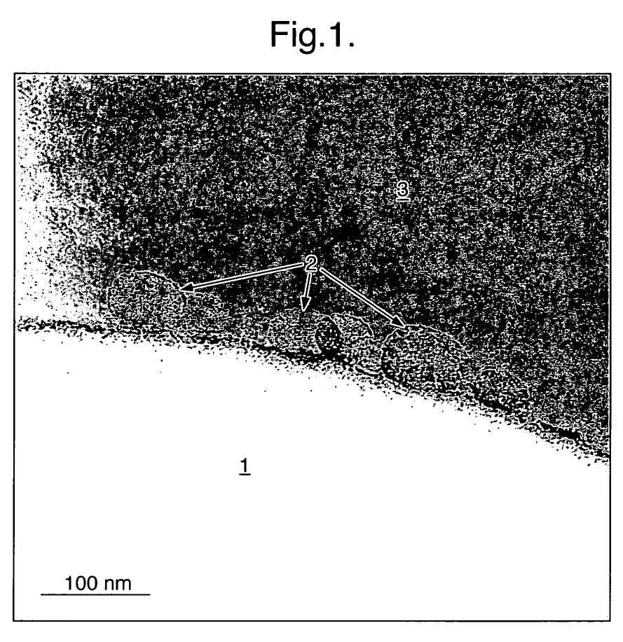

FIG. 1 is a Transmission Electron Microscopy (TEM) picture of an ungelatinised non-heated emulsion of the present invention.

### DETAILED DESCRIPTION OF THE INVENTION

In the context of the invention, the terms “fat” and “oil” are used interchangeably. The term oil encompasses both triglyceride oils and diglyceride oils.

For the purpose of the present invention, % by weight or wt % is defined as weight percent on total product weight unless otherwise indicated.

In the context of the invention, an emulsion is regarded as “stable” if it does not separate into its component phases for at least 3 months upon storage under refrigerated conditions.

Normally, it is necessary to add an emulsifier to the basic oil and water components in order to form a stable oil-in-water emulsion. Suitable emulsifiers which can be added to form an oil-in-water emulsion are emulsifiers which have an HLB value in the range from 8 to 18. Suitable examples of such emulsifiers include polysorbates (eg. Tweens), ethoxylated monoglycerides, glyceryl esters, soy lecithin, sodium stearyl lactate and mixtures thereof. The term “added emulsifier” therefore refers to any such emulsifier which is separately added to the basic oil and water components of the emulsion.

Starches

Emulsions and food products prepared by the process of the invention may vary considerably in terms of ingredients and the quantities of those ingredients which are utilised. For instance, the quantity of flour and/or starch may vary according to the desired thickness (viscosity) of the emulsion or resultant food product. However, it is preferred that the flour and/or starch comprises 1 to 15% by weight, more preferably 5 to 10% by weight, of the emulsion or food product.

A variety of flours and/or starches can be used, including native (unmodified), modified and heat-treated flours and/or starches. However, it is preferred that native flours and/or starches are used. Preferred flours include soft wheat flour, hard wheat flour, potato flour, rice flour, corn flour, tapioca flour, semolina, and mixtures thereof. Preferred starches include wheat starch, potato starch, rice starch, corn starch, tapioca starch and mixtures thereof. However, it is preferred that the flour and/or starch is wheat flour and/or wheat starch, especially wheat flour.

Preferably, the wheat flour and/or starch is a native wheat flour and/or starch, that is, an unmodified wheat flour and/or starch.

The starch must be ungelatinised. Although each starch variety has different properties starch in an aqueous medium may begin to gelatinise partially at a temperature of about 55° C. and rapidly gelatinises at a temperature of about 64 or 65° C.

Oil

The quantity of oil will affect the texture of the emulsion and the resultant food product. The oil preferably comprises 1 to 15% by weight, more preferably 5 to 10% by weight, of the emulsion or food product. Preferred oils include dairy fats, such as butterfat and margarine, and vegetable oils, such as coconut oil, palm oil, sesame oil, walnut oil, soybean oil, groundnut oil, sunflower oil, corn oil, rapeseed oil, olive oil, and mixtures thereof. Butter, clarified butter, sunflower oil, corn oil, rapeseed oil, olive oil and mixtures thereof are especially preferred.

Aqueous Liquid

The quantity of aqueous liquid may vary according to the desired thickness (viscosity) of the emulsion or resultant food product. However, it is preferred that the aqueous liquid comprises 70 to 95% by weight, preferably 75 to 90% by weight, of the emulsion or food product. The aqueous liquid may be any liquid which contains or comprises water. Preferably, the aqueous liquid is selected from water, flavoured water (such as stock), and mixtures thereof. If stock is used, this may be a vegetable stock or a meat stock, such as beef or chicken stock.

The Process

The process involves blending the oil, ungelatinised flour and/or starch and aqueous liquid at high shear to produce a stable oil-in-water emulsion which contains ungelatinised flour and/or starch.

The process of the invention is carried out at a temperature of below 50° C. Preferably it is carried out at room temperature. Room temperature may be from 10 to 30° C., preferably from 15 to 25° C. However, typically, room temperature is around 20° C.

Heating is unnecessary and this ensures that the starch remains ungelatinised. The ungelatinised product of the process has a low viscosity as compared to the food product it can become upon heating.

High Shear

The high shear utilised in the process of the invention can be produced by subjecting the mixture to sonication using a power ultrasound system. Power ultrasound typically operates in the frequency range of 20-200 kHz, and it is principally a pressure wave. Acoustic cavitation is invariably associated with power ultrasound and the two main types can be distinguished as inertial (or transient) or stable cavitation. Transient cavitation bubbles can generate pressure shock waves, high shear and high temperatures. In addition, free radicals may also be produced. It is the transient type of cavitation that is thought to cause most of the sonochemical changes in the process of the invention. Suitable power ultrasound systems include commercially available ultrasonic horns, such as a Branson 450L horn.

The application of power ultrasound to promote emulsification has been known for many years. For example, oil can be dispersed in water and the size distribution of the droplets decreases (Abismail, B., Canselier, J. P., Wilhelm, A. M., Delmas, H., & Gourdon, C. 1999, “Emulsification by ultrasound: drop size distribution and stability”, Ultrasonics Sonochemistry, vol. 6, no. 1-2, pp. 75-83 and Behrend, O. & Schubert, K. Ax. H. 1999, “Influence of continuous phase viscosity on emulsification by ultrasound”, Ultrasonics Sonochemistry no. 7, pp. 77-85). However, these emulsions are only permanently stable when they are sonicated in the presence of an added emulsifier. Generally, in the absence of an added emulsifier, the stability of the emulsion is temporary as eventually the dispersed droplets will coalesce to form larger oil droplets. These droplets are then susceptible to creaming, resulting in a phase separation. The coalesced particles cannot be redispersed by simple shaking, in contrast to the emulsion of the present invention.

To date, the presence or formation of an oil and protein complex or association in an unmodified flour, oil and water system has not been found in the literature.

The high shear utilised in the process of the invention can also be produced by subjecting the mixture to high pressure homogenisation. Preferably, the homogenisation occurs at a pressure of 20-2000 bar, more preferably 50-900 bar. Suitable apparatus for carrying out such high pressure homogenisation includes commercially available homogenisers, such as those made by Niro Soavi e.g., “Panda” model NS 1001 L.

A stable emulsion can also be produced during processing by using a double concentration of the standard strength of wheat flour/starch and oil and then diluting the resultant concentrate with an aqueous liquid. For instance, a double concentrate, that is, containing twice the normal quantity of flour and/or starch or oil, produced using a power ultrasound system appeared to have the same properties as a standard emulsion when diluted and then heated to 95° C. for 20 minutes. The process of the invention may therefore include a further step of concentrating the wheat flour/starch and oil to produce a concentrate and a further step of diluting the concentrate with an aqueous liquid, preferably water.

The Emulsion

This process has the effect of causing a complex or association to be formed between the oil and proteins of the flour and/or starch. It is known that flour is composed of starch granules and proteins. For instance, wheat flour is composed of starch granules and the wheat proteins glutenin and gliadin. The starch granules are also coated on their surfaces by protein. Typically, the starch granules clump together around the proteins. However, microscopy has been used to show that the process of the invention removes the starch granules from the flour proteins. It also emulsifies and stabilises the oil phase to form an oil-in-water emulsion. The oil droplets appear to surround the proteins and surface of the starch granules. The size of the oil droplets remains constant with time and does not require any of the additional emulsifiers that are typically required to prevent the coalescence of oil droplets and irreversible phase separation. During the process of the invention, the flour proteins have also been observed to progressively shrink and become more condensed in size as the starch is removed from the protein surfaces. The process produces a unique and permanent association or complex between the protein and oil and it is thought that this ‘association’ is responsible for the stability of the emulsion.

It is not yet finally understood how the oil droplets are stabilised. However, the emulsified oil droplets appear to bind strongly with both the condensed protein and the protein coating surrounding the starch granules. Using other processing techniques, such as stirring, the production of this unique association or complex has not been observed. Thus, without wishing to be bound by theory, it is thought that the oil-in-water emulsion may be stabilised by proteins and lipophospholipids which are naturally present in high concentrations on the surface of the proteins and starch.

The stable emulsion formed by the process of the invention is quite unique in that it can be formed using only flour and/or starch, an oil and an aqueous liquid, that is, no added emulsifier is required. Preferably, the emulsion comprises wheat flour, oil and water. The emulsion can be used as an alternative to a roux and thus eliminates the requirement for a roux in the production of a food product such as a white sauce.

Once prepared, the stable emulsion can optionally be stored in a refrigerator. Some sedimentation may occur during storage. However, this can be removed by gentle shaking. When required to produce a final food product, such as a white sauce, the ungelatinised emulsion can be removed from the refrigerator and heated to cause gelatinisation. The process of the invention may therefore include a further step of heating the emulsion to form a food product, such as a sauce.

A milk product may also be added to the emulsion. Preferably, the milk product is added to the cold emulsion before the emulsion is heated to form a food product. The milk product may be a fresh milk product, such as full fat milk, semi-skimmed milk, skimmed milk or cream. Alternatively, the milk product may be a dried milk product, such as a milk powder, especially skimmed milk powder. Mixtures of fresh and dried milk products can also be used. It is envisaged that fresh milk products will be preferred for domestic use and dried milk products will be preferred for industrial use. The presence of a milk product can be useful in order to impart a creamy texture to the food product. Also, the presence of a milk product may act as a thickener thereby increasing the final viscosity of the food product. Preferably, the milk product comprises 2 to 70% by weight, more preferably 5 to 55% by weight, of the final food product.

In some instances, it may be desirable to increase the viscosity of the continuous phase of the emulsion to prevent sedimentation. This can be achieved by the addition of a thickening agent. Suitable thickening agents include polysaccharides and/or gums, such as locust bean gum, xanthan gum, carrageenans, alginates and pectins.

Forming a Food Product

A food product may be obtained by heating the product of the process, so that gelatinisation of the starch can occur.

Heating can be carried out by conventional means, for instance, using a gas or electric cooker. In this case, the emulsion is typically heated to at least 85° C., preferably 95° C. Alternatively, heating can be carried out in a domestic microwave oven (typically 600-1200W). It is desirable for stirring to occur during heating, especially when conventional heating methods are used.

The food product may be selected from the group consisting of sauces, custards, soups, gravies and casseroles. However, it is preferred that the food product is a sauce, particularly a white sauce. Flavoured versions of white sauce are also preferred. These may be prepared by adding a suitable flavouring. Alternatively, the flavouring may be achieved by using a flavoured stock or by introducing a further component, such as a herb, spice, cheese, nuts, alcohol or a mixture thereof. Sugar may be added to produce a sweet sauce. Seasonings, such as salt and pepper, and colourings may also be included.

As mentioned above, the invention also concerns a stable oil-in-water emulsion obtainable by a process as described above. As previously discussed, the emulsion has a unique microstructure comprising oil-protein complexes or associations. Also, the oil droplets in the emulsion and the final product are generally of a smaller size than are found in similar products made by conventional methods.

### EXAMPLES

### Example 1

Homogenisation (Niro Soavi) Production

50 g Sunflower oil, 50 g wheat flour and 900 g water were weighed out. The ingredients were then dispersed by gentle stirring and placed into the entrance funnel of a benchtop high pressure-homogeniser (Niro Soavi “Panda” NS 1001 L model). The machine was then switched on and samples collected at pressure settings of 20, 50, 100, 350 and 860 bar at a flow rate of 10 litres/hour. The resultant ungelatinised emulsions were then collected and stored in a refrigerator at 1-5° C. Any sedimentation of the emulsion was easily dispersed by gentle shaking. The association, dispersion and emulsification could still be observed after storage for 3 months. Heating with stirring produced a gelatinised sauce which has a similar viscosity to a conventionally produced sauce.

### Example 2

Ultrasound (Branson Probe) Production

5 g Sunflower oil, 5 g wheat flour (or starch) and 90 g water were weighed out into a temperature controlled vessel. A Branson 450L, 12.7 mm diameter ultrasonic horn was lowered into the mixture and ultrasound was applied at an output setting of 5, 100% duty cycle (continuous, power=approximately 100 W) for 0.5 to 5 minutes. The resultant ungelatinised emulsion was then collected and stored in a refrigerator at 1-5° C. Any sedimentation of the emulsion was easily dispersed by gentle shaking. The association, dispersion and emulsification could still be observed after storage for 3 months. Heating with stirring produced a gelatinised sauce which has a similar viscosity to a conventionally produced sauce.

### Example 3

The method of Example 1 was repeated except that 810 g water was used and 90 g skimmed milk powder was added to the emulsion prior to heating.

### Example 4

The method of Example 2 was repeated except that 81 g water was used and 9 g skimmed milk powder was added to the emulsion prior to heating.

### Example 5

The method of Example 2 was repeated except that the emulsion was heated in a domestic microwave oven at 1 kW for 1 minute.

### Example 6

Materials and Methods

(i) Ultrasound

A commercial ultrasonic horn (Branson 450L, 12.7 mm diameter horn) was immersed into a double walled glass beaker containing 5 g wheat flour, 5 g butter (or sunflower oil), and 90 g distilled water. The ingredients were mixed using a magnetic flea, and the ultrasound was applied. The temperature was maintained at 20° C. during the sonication treatment. In these examples; the ultrasound was applied using the Branson probe horn at output setting 5,100% from 0-10 minutes.

(ii) Controls

(a) Stirring Only

Various control experiments were also performed to examine any differences obtained from other mixing and emulsification methods. In the first control experiment, the experiment described above was performed, but no ultrasound was applied. In this case mixing occurred only with the magnetic stirrer.

(b) Mixing

Mixing was performed using a Silverson L4R mixer for the following combinations at room temperature
1 Wheat flour, oil and water mixed
2 Sonicated wheat flour+water mixed with oil
3 Sonicated oil+water mixed with wheat flour
   (c) Stable Cavitation System

The ingredients were placed into an ultrasonic cell which only produces predominantly stable cavitation (in water) and sonicated for 45 minutes at 20° C.

Results

During sonication by high power ultrasound (Branson), there were several changes in the sample. Firstly, the colour of the sample changed from creamy yellow to white. This was most probably due to the emulsification of the oil phase into smaller droplets which refracted light more than the non-sonicated sample which contained larger oil droplets. After sonication, the product contained no visible lumps of wheat flour. Light microscopy showed separation of the starch granules from the wheat proteins, the starch granules were no longer clumped together and remained ungelatinised (this was detected by the birefringence of the granules under polarised light). The structure of the wheat proteins also appeared to be condensed in size. The oil droplets were emulsified into smaller droplets. The degree of wheat starch separation from the wheat protein, wheat protein shrinkage, and emulsification of oil droplets all increased with sonication time from 0 to 10 minutes. An unusual black aggregated assembly was observed using the light microscope. Using confocal analysis, the protein and oil components of the product could be identified, and the black assembly appeared to be an association of the droplets of oil to the protein phase. The oil droplets appeared to be mainly associated with both the condensed wheat proteins, and the proteins surrounding the starch granules. The association of individual oil droplets with the protein-coated starch granules was also observed in a sample of wheat starch (which does not contain the wheat flour proteins: gluten and gliadin), although there was much more free oil present in this case. The aggregation of the droplets of oil to the protein coating surrounding the wheat starch surface could also be observed at higher magnifications using Transmission Electron Microsopy (TEM).

In the systems containing wheat flour, the associations could be observed even after 0.5 seconds of sonication, although the amount of starch granule separation from the wheat protein, emulsification and association were much more pronounced after 10 minutes. The complexes or aggregates of protein and oil remained for over 3 months in a refrigerated sample. The ungelatinised emulsion did show some sedimentation 1 hour after sonication. However, unlike the control samples, the emulsion could be redispersed by gentle shaking. After storage for 3 months in a refrigerator, the emulsion could still be redispersed by gentle shaking. After heating in a domestic microwave for 1 minute at 1000W, the starch underwent gelatinisation and the resulting food product had a comparable viscosity to a conventional product.

The structural differences between the emulsions are summarised in Table 1 below:—

TABLE 1

| | Ultrasound | Control |
|---|---|---|
| Appearance | White liquid - no | Yellow slurry which |
| | visible lumps. | phase separates after |
| | Sedimentation occurs | one hour. Cannot be |
| | after approximately | dispersed by shaking |
| | one hour, but can be | |
| | dispersed easily by | |
| | shaking | |
| Light | Starch separated from | Starch clumped to |
| microscopy | wheat flour proteins | proteins. Proteins |
| | and oil emulsified. | not condensed. |
| | Exposed wheat proteins | No oil |
| | appear condensed in | emulsification. |
| | size. Large areas of | No black |
| | black associations. | associations. Starch |
| | Starch ungelatinised | ungelatinised |
| | (birefringent) | (birefringent) |
| Confocal | Starch separated from | Starch clumped to |
| microscopy | wheat flour proteins. | proteins. No oil |
| | Large areas of black | emulsification. No |
| | associations | association of oil to |
| | identified as | protein. |
| | emulsified oil | |
| | aggregated with | |
| | proteins | |
| Transmission | Starch separated from | Starch clumped to |
| Electron | wheat flour proteins. | proteins. No oil |
| Microscopy | Emulsified oil | emulsification. No |
| (TEM) | droplets associated | association of oil |
| | with wheat flour | to protein. |
| | proteins. | |

FIG. 1 highlights the novel aggregated structure of oil and protein which was observed using TEM. The sample was produced by sonicating a mixture of wheat starch, sunflower oil and water. As shown in FIG. 1, the protein coated starch granule (1) is surrounded by discrete droplets of oil (2) within a continuous water phase (3). The associations could not be produced using any other methods such as stirring or mixing.

The droplets of oil produced by the power ultrasound appeared to be associated with the protein phase. Even though the sample did not contain any added emulsifiers, the oil droplets did not change size with time, and therefore appeared stable. During time stability trials, the samples were stored in a refrigerator for 3 months. Some sedimentation occurred. However, the oil-protein complex was still maintained and the emulsion could be redispersed by gently shaking the sample. In contrast, the samples which were produced without any ultrasound showed irreversible phase separation. The emulsified oil droplets gradually coalesced and then creamed. Shaking did not redisperse the oil drops.

The formation of the aggregated starch-protein complex was investigated using an ultrasonic system which only produced predominantly the stable type of cavitation. The production of a stable emulsion could not be produced in this system after 45 minutes of sonication. It is thought that the structural changes observed in the stable emulsion can only be produced by the predominantly transient type cavitation which are produced by the Branson probe device.

The sonicated ungelatinised emulsion could be used as an alternative to a conventional roux. Trials using a domestic microwave oven showed that the starch-containing emulsion could be gelatinised to produce a viscous sauce after 1 minute of heating at 1 kW. The viscosity of the sauce measured at 60° C. was comparable to the conventional chef's sauce.

1. A process for the preparation of a stable ungelatinised starch-containing oil-in-water emulsion in the absence of an added emulsifier and without forming a roux, which comprises subjecting a mixture of ungelatinised flour and/or starch, an oil and an aqueous liquid to high shear carried out at a temperature of less than 50° C.

2. A process according to claim 1 in which the high shear is produced by subjecting the mixture to sonication using a power ultrasound system.

3. A process according to claim 2 in which the power ultrasound system produces predominantly transient cavitation.

4. A process according to claim 2 in which the power ultrasound system operates in a frequency range of 20-200 kHz.

5. A process according to claim 1 in which the high shear is produced by subjecting the mixture to high pressure homogenisation.

6. A process according to claim 5 in which the homogenisation occurs at a pressure of 20-2000 bar, preferably 50-900 bar.

7. A process according to claim 1 in which a complex is formed between the oil and proteins of the flour and/or starch.

8. A process according to claim 1 in which the flour and/or starch comprises 1 to 15% by weight, preferably 5 to 10% by weight, of the emulsion.

9. A process according to claim 1, which is carried out at room temperature.

10. A process according to claim 1 in which the oil comprises 1 to 15% by weight, preferably 5 to 10% by weight, of the emulsion.

11. A process according to claim 1 in which the aqueous liquid comprises 70 to 95% by weight, preferably 75 to 90% by weight, of the emulsion.

12. A process according to claim 1 in which the aqueous liquid is selected from water, stock and mixtures thereof.

13. A process according to claim 1 which includes a further step of adding a milk product, preferably a skimmed milk powder, to the emulsion.

14. A process according to claim 1 which includes a further step of heating the emulsion to form a food product.

15. A stable oil-in-water emulsion obtainable by a process according to claim 1.

16. A stable ungelatinised starch-containing oil-in-water emulsion in the absence of an added emulsifier characterised in that it has a microstructure comprising oil-protein complexes or associations.

17. A food product obtainable by a process according to claim 15.

18. A food product according to claim 17, selected from the group consisting of sauces, custards, soups, gravies and casseroles.
